(19) United States
(12) Patent Application Publication
(10) Pub. No.: US 2018/0211484 A1
(43) Pub. Date: Jul. 26, 2018

(54) Mapping Virtual Achievements Into Real Life

(71) Applicant: Ian Nelson, Vineyard, UT (US)

(72) Inventor: Ian Nelson, Vineyard, UT (US)

(21) Appl. No.: 15/875,961

(22) Filed: Jan. 19, 2018

Related U.S. Application Data
(60) Provisional application No. 62/448,754, filed on Jan. 20, 2017.

(51) Int. Cl. G07F 17/32; G06Q 30/02; A63F 13/53; A63F 13/46; A63F 13/44; A63F 13/85; A63F 13/35; A63F 13/795; A63F 13/798; A63F 13/61; A63F 13/69

(52) U.S. Cl. CPC G07F 17/3253; A63F 13/822; A63F 13/53; A63F 13/46; A63F 13/44; G07F 17/3279; A63F 13/85; G07F 17/3255; A63F 13/35; G07F 17/3239; G07F 17/3274; A63F 13/795; A63F 13/798; A63F 13/61; A63F 13/69; G07F 17/323; G06Q 30/0209

(57) ABSTRACT

An achievement server may provide descriptions or specifications of virtual environment achievements to a user. A user may report to the achievement server the user's virtual achievements. This report may include verification of such virtual achievements. Based on the reported virtual achievements, the achievement server may unlock products or services for the user. In one embodiment, the achievement server may unlock tier-1 shoes (e.g., red shoes) for the highest level of achievement, tier-2 shoes (e.g., blue shoes) for the next-highest level of achievement, tier-3 shoes (e.g., orange shoes) for the next-highest level of achievement, tier-4 shoes (e.g., yellow shoes) for the next-highest level of achievement, and tier-5 shoes (e.g., green shoes) for the next-highest level of achievement.

### BACKGROUND OF THE INVENTION

Virtual environments are increasing in ubiquity and popularity. Virtual environments include at least video games, computer games, and other online games and environments. Pseudo-virtual environments, e.g., augmented reality, are also becoming more ubiquitous and popular.

Many people invest significant time and resources to improve their respective state in a virtual environment, e.g., by completing levels, obtaining items, gaining powers or abilities, collecting points, achieving a rank, competing against and/or defeating opponents or other users, and in many other ways.

Even though an individual may have achieved significant success in a virtual environment—often through a significant investment of time, resources, and skill—often such a user has nothing to evidence, show, identify, or memorialize his or her accomplishments in the real, physical world (i.e., outside of the virtual environment). This can be disheartening to the user after his or her significant investment and success. Also, the absence of physical manifestations of success or status in a virtual environment makes it difficult, if not impossible, for users of one or more virtual environments to easily identify each other and appreciate another's successes, rank, and/or status in one or more virtual environments.

What is needed a better way to map virtual achievements to real life.

### BRIEF SUMMARY OF THE INVENTION

A system and method are disclosed for mapping virtual achievements, i.e., achievements in a virtual environment or pseudo-virtual environment, into the real, i.e., physical, world. A virtual environment may comprise a video game, computer game, or one of many other virtual environments. A pseudo-virtual environment may comprise augmented reality.

In one embodiment, an achievement server may provide descriptions of virtual achievements to a user, receive reports of one or more virtual achievements from a user, and, based on reported virtual achievements, unlock products or services for the user.

Virtual achievements may include, but are not limited to, attaining a score, obtaining items or milestones, completing levels or challenges in a particular period of time, achieving a particular outcome in head-to-head competitions, achieving a status, achieving a rank, obtaining powers or abilities, or any other metric for a virtual environment.

A report of a virtual achievement may include one or more verifications, or may rely upon one or more verification solutions. For example, a verification of a virtual achievement may comprise a screenshot, a video, a YouTube link, a Twitch stream, a witness statement, a code, third-party verification, or any other solution for verifying a virtual achievement.

In one embodiment, “unlocking” a product or service may comprise making the product or service available at a cost, or at a reduced cost, or for free.

In one embodiment, the product may be shoes, and different colors of similarly-styled shoes may be unlocked based on a user's virtual achievements. For example, in one tiered scheme, red shoes may signify a highest level of virtual achievement, e.g., tier-1, blue shoes may signify a significant (but not highest) level of virtual achievement, e.g., tier-2, orange shoes may signify tier-3 virtual achievement, yellow shoes may signify tier-4 virtual achievement, and green shoes may signify tier-5 virtual achievement.

### BRIEF DESCRIPTION OF THE DRAWINGS

FIG. 1 depicts an exemplary system as disclosed herein.

FIG. 2 depicts an exemplary achievement report.

FIG. 3 depicts an exemplary set of achievements.

FIG. 4 depicts an exemplary mapping of products to achievement levels.

FIG. 5 depicts a flowchart for an exemplary method as disclosed herein.

### DETAILED DESCRIPTION OF THE INVENTION

A system and method are disclosed for mapping achievements in a virtual environment into products and other aspects in the non-virtual, or actual, world.

Table of Reference Numbers from Drawings:

| Reference | |
|---|---|
| Number | Description |
| 110 | achievement server |
| 120 | user |
| 130 | reporting device |
| 150 | network |
| 160 | challenge server |
| 200 | achievement report |
| 300 | achievement repository |
| 310a-n | achievements |
| 400 | mapping of products to achievements |
| 410 | exemplary mapping of product to achievements |
| 420 | exemplary mapping o product to achievements |
| 430 | exemplary mapping of product to achievements |
| 440 | exemplary mapping of product to achievements |
| 500 | flowchart showing exemplary method for mapping virtual |
| | achievements into real life |
| 510 | step for method 500 |
| 520 | step for method 500 |
| 530 | step for method 500 |
| 540 | step for method 500 |
| 550 | step for method 500 |

The following table is for convenience only, and should not be construed to supersede any potentially inconsistent disclosure herein.

“Virtual environment,” as used herein, includes video games, computer games, app games, other electronic games, other virtual environments, or other partially virtual environments or pseudo-virtual environments. “Games,” as used herein, include but are not limited to, video games, computer games, app games, virtual environments, augmented reality, and pseudo-virtual (or partially-virtual) environments (e.g., an environment that includes both real world aspects as well as virtual aspects). Augmented reality may refer to a game that requires real-life actions to play in a virtual environment. Pokemon Go® is one example of augmented reality, in which a player's surroundings are converted into a part of the game, and wherein players interact with their actual environment, as virtually augmented, to achieve with the augmented reality game. One example of a pseudo-virtual environmental may be the game/device Bop-It®.

Virtual environment achievements may include, but are not limited to, accomplishments or thresholds in a virtual environment, for example: attaining a particular score; obtaining particular items or milestones; traversing levels or other challenges in a particular period of time; beating one or more other players in head-to-head, multiplayer, or comparison competitions; completing a level in a campaign; obtaining one or more milestones, items, or levels within a campaign; attaining one more particular performance levels in consecutive matches, campaigns, or levels, or on consecutive days, or in a particular percentage of consecutive matches, campaigns, or levels, or consecutive days; completing or attaining a particular performance level in a daily challenge; maintaining a particular level of consistency over a period of time; verified improvement; achievements based on age or other personal characteristics; or any other measure of competency or performance in a virtual environment, whether individually, or relative to others, or a combination of such, or otherwise as may be known in the art.

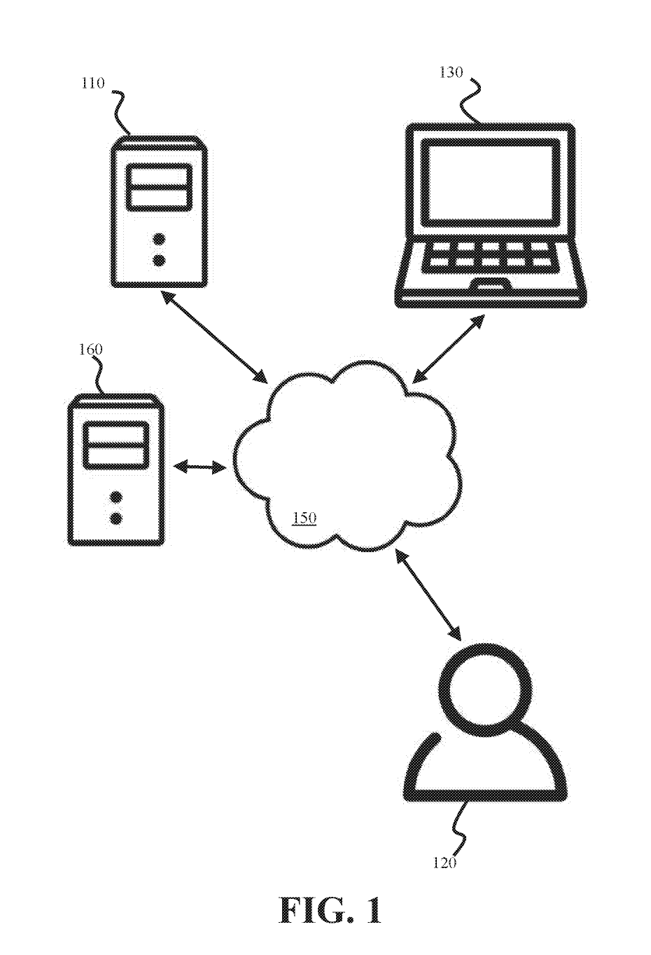

Referring to FIG. 1, in one embodiment, an achievement server 110 may receive, store, compute, and/or provide information relating to virtual environment achievements. As used herein, a server may comprise a physical server, or multiple servers connected as is known in the art, or a cloud computing/storage/communication solution, or a virtual server environment, or any combination of such, or any other computing/storage/communication solution as may be known in the art.

Achievement server 110 may receive, from a user 120 or other reporting device 130, a report of a virtual environment achievement, which may also be referred to as an achievement report 200. An achievement report may be received through a data communications network (e.g., local area network, wide area network, Internet, direct communications interface, or any other data communications interface known in the art), telephone interface, cell phone interface, electronic input interface (e.g., keyboard, mouse, touch screen, voice recognition, haptic, motion recognition, or other electronic input interfaces known in the art), or any other data or communication interface, medium, system, or technology known in the art. In one embodiment, achievement server 110 may receive achievement report 200 over network 150.

Achievement report 200 may be prepared manually by user 120, automatically by software and/or hardware on a user device 130, by a virtual environment, e.g., game, with which the report is associated, or any other way known in the art. The report may also be an oral report provided via telephone, sound data file, or any other known technology for voice or sound data.

For example, achievement server 110 may provide an achievement report interface available over the Internet 150 through a web browser or app. The achievement report interface may provide interface components for user 120 to input data for virtual environment achievement 300. In one embodiment, user 120 may use a keyboard and/or mouse to type in information and/or to interact with interface components for entering achieve report information. In some embodiments, user 120 may direct or enable a virtual environment or device in communication with a virtual environment to prepare and/or provide an achievement report 200 to achievement server 110. In some embodiments, user 120 may obtain a screenshot evidencing a virtual achievement, e.g., using an image capture device (e.g., cell phone camera, camera, digital camera) or using screen capture technology such as ScreenPresso® or ALT+PrtSc or any other image capture technology or solution known in the art. In one embodiment, user 120 may upload a screen capture or screenshot to a web page, or to a cloud storage location (e.g., Google® Drive).

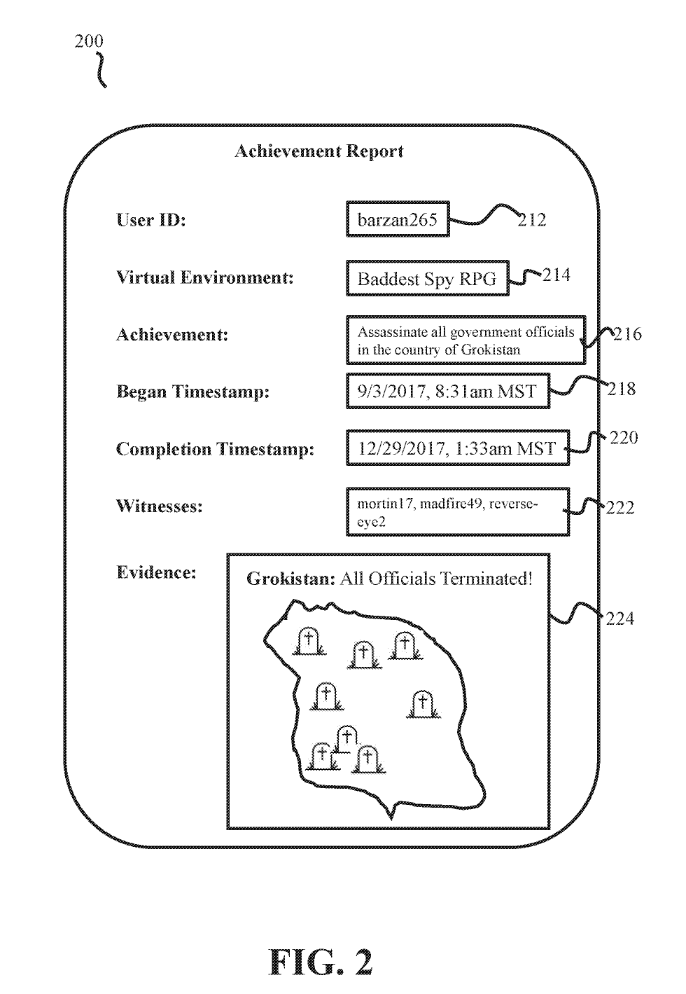

As shown in FIG. 2, the information included and/or associated with an achievement report 200 may include, but does not necessarily include, and is not necessarily limited to, user identification 212 (e.g., name, virtual name, virtual identity, user number, unique user identifier, email address, virtual environment profile identifier, or account name or profile name, and/or gamer tag); identification of the virtual environment 214 (e.g., name of a computer game, video game, app, etc.); description/identification of achievement 216; timestamp 218 for beginning of achievement; timestamp 220 for end of achievement; witnesses 222; and corroborating evidence 224.

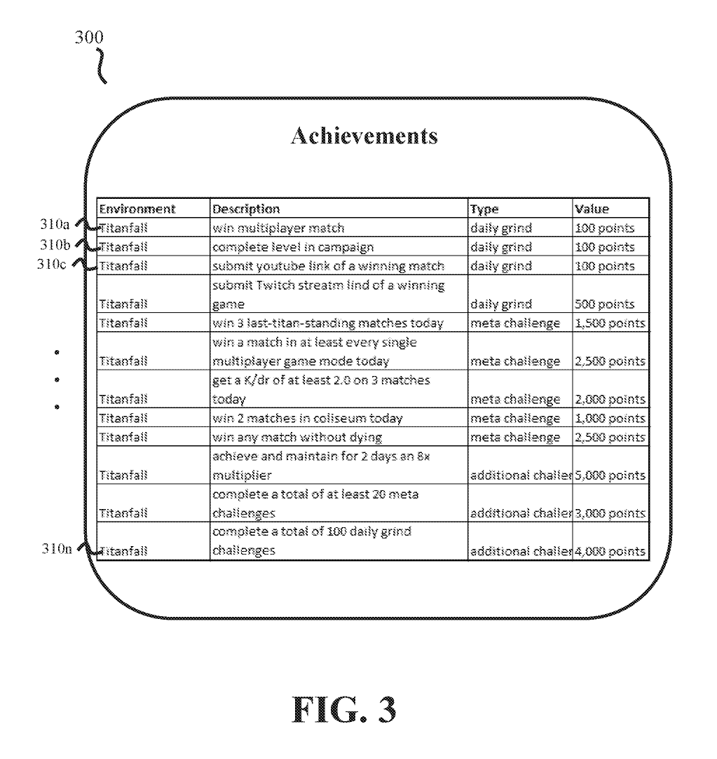

FIG. 3 shows an exemplary repository 300 of achievements 310a-n, or subset of achievements. For example, as shown in achievement 310a, the virtual environment is Titanfall, the description of the achievement is “win multiplayer match,” the type of the achievement is “daily grind,” and the value of the achievement is “100 points.”

In some embodiments, the description/identification of a virtual environment achievement 300n could be a textual description of virtual environment achievement 300, or could be a selection from a pre-populated set of virtual environment achievements associated with one or more particular virtual environments, or could be a visual representation of a virtual environment achievement, or could be provided through a search interface for a virtual environment achievement, or could be any other approach in the art for describing, identifying, or selecting a virtual environment achievement 310n, or a set 100 of virtual environment achievements.

In one embodiment, an achievement report interface may include an interface through which user 120 may add a new, or custom, virtual environment achievement 300 that user 120, or other users, may then attempt to accomplish or improve upon. The achievement report interface may allow a user to input or upload any information that may be relevant to or necessary for defining or describing a virtual environment achievement 300, including but not limited to a name or other identifier for the new virtual environment achievement, identification of the associated virtual environment(s), a description of the new virtual environment achievement, a description of or suggestion for a way for verifying accomplishment of a new virtual environment achievement, a description of the difficulty or suggested difficulty level of the new virtual environment achievement, and/or any other information related to a new or proposed new virtual environment achievement.

The achievement report interface may also include one or more components for submitting corroborating evidence of accomplishment of a virtual environment achievement. Corroborating evidence may include, but is not limited to, screenshots, video. YouTube links, Twitch stream, witness statements, codes or other verification information from virtual environments, references to third-party verification services, or any other solution for verifying accomplishment of a virtual environment achievement. In one embodiment, makers of virtual environments, e.g., makers of video games, computer games, and apps, may build into their respective virtual environments codes or other verification systems that verify attainment of a particular achievement within the respective environment. For example, when a user (e.g., game player) of a virtual environment attains a virtual environment accomplishment, the virtual environment may provide a verification code to the user. Some embodiments may employ cryptography or other technological means for verifying user identity, timing, actual accomplishment of a virtual environment achievement, and any other information related to verification of a virtual environment achievement 310n.

In another embodiment, makers of consoles or other execution systems, e.g., computers, video game consoles, and smart phones, may build into their respective operating systems or software virtual environment achievement verification systems. Such systems may use codes or any other verification system known in the art. A virtual environment may be configured to automatically provide verification information, e.g., a code, to achievement server 110, or to provide verification information in response to achievement server 110's request for verification information, or to provide verification information in response to a manual request from user 120, representative of achievement server 110, achievement server 110, or third-party verification entity.

In another embodiment, user 120 may provide authentication information, e.g., username and password, so that achievement server 110, or another entity, which could be a third-party entity, may verify reported achievement information, e.g., by logging into the user's account for a particular virtual environment.

In some embodiments, user 120 may provide verification information other than over the Internet or other communication network. For example, in addition to providing or submitting verification information over the Internet, or via another communication network, a user may send verification information in electronic or non-electronic format in the mail, or via hand delivery, or by manually inputting such verification information, or in any other way known in the art.

In one embodiment, a challenge server 160 may periodically promulgate, disseminate, or advertise challenges for various virtual environments. For example, challenge server 160 may disseminate via email a daily challenge comprising obtaining, in one day, a particular number of items, or getting a particular number of kills, or any other virtual environment challenge as may be known in the art. As will be appreciated, a challenge published or promulgated by challenge server 160 may take many forms other than obtaining a goal or achievement in one day. The challenge server may publish, promulgate, advertise, or otherwise disseminate any challenge that may require efforts in a virtual or partially-virtual environment as described herein, or that may comprise an achievement as described herein. For example, challenge server 160 may also provide challenges that must be completed in a time period other than one day, e.g., challenges that must be completed in some limited or finite period of time: minutes, hours, days, weeks, etc.

In one embodiment, achievement server 110 may store achievement report information in a database, which may be located on achievement server 110, on another server, in the cloud, or in any other well-known solution for storing electronic information or for otherwise storing information. In general, stored achievement report information may reflect achievements for one or more individual users or for multiple users collectively.

In some embodiments, in addition to reporting on actual achievements, users or other entities or parties may report progress toward achievements.

In some embodiments, a group user may comprise a group of users or other entities, and achievement server 110 may perform, for a group user, functions analogous to the functions provide for a user. Achievement server 110 may additionally compute and/or provide rankings, ratings, comparisons, or individual indicators for members of a group user. In such embodiments, groups of users, instead of individual users, may pursue virtual environment achievements by working together in teams, or under circumstances in which individual virtual environment achievements or sub-achievements are aggregated and mapped to a team score or other representation of progress toward or accomplishment of a virtual environment achievement.

In one embodiment, achievement server 110 may include a point computation engine, and a point system may be employed, in whole or in part, to track and/or determine progress toward and/or accomplishment of one or more virtual environment achievements.

In general, a mechanism other than points may be employed for translating achievements into awards. Many such systems or approaches are known in the art. For example, approaches may include tiered schemes, ranking schemes, rating schemes, relative ranking/rating schemes, number score schemes (assigning a number/point score to each achievement), tally schemes (counting the number of achievements accomplished, or counting the number of times a particular achievement, or element in a set of achievements, is accomplished), or other known systems or approaches for mapping achievements into awards.

The point computation engine may, based on a user's virtual environment achievement(s), compute a point value or point level. This computation may be based, but is not limited to, some or all of the following factors, or some combination of such: timing of achievements (when completed; how long it took to complete); difficulty; age of user, experience level of user; virtual environment associated with each achievement; number of virtual environment achievements or achievement having particular characteristics; and any other factors.

Point values or other achievement metrics may be based on prior achievements as well as future achievements. For example, a user may complete a particular achievement prior to becoming aware of a particular achievement description and value. Upon reporting or verifying his/her status, rank, standing, level, grade, stats, or other state metric in a particular virtual environment, the user may determine, or the achievement server may determine and/or inform the user, that the user's status, rank, standing, level, grade, stats, or other state metric is sufficient to unlock or make available, in full or in part, award products or services. The achievement server may unlock or make available, in full or in part, the associated award products or services.

Achievement server 110 may store, or offer, or generate, or provide, an award schedule that associates point values or other achievement metrics or levels to the availability of particular products, lines of products, services, lines of services, experiences, or benefits. For example, the award schedule may indicate that a particular pair of shoes should be available for purchase when a user has achieved a particular aggregate point threshold. In another embodiment, the cost of a particular product may decrease as a user's aggregate point total increases. In another embodiment, one or more products may become available based on a particular achievement or a subset or set of achievements.

In one embodiment, various pairs of shoes may be made available based on a user's achievement(s). The various pairs of shoes may be distinctive in styling, and may have different colors to indicate various achievement levels. For example, a line of distinctive shoes may include red shoes, blue shoes, orange shoes, yellow shoes, and green shoes.

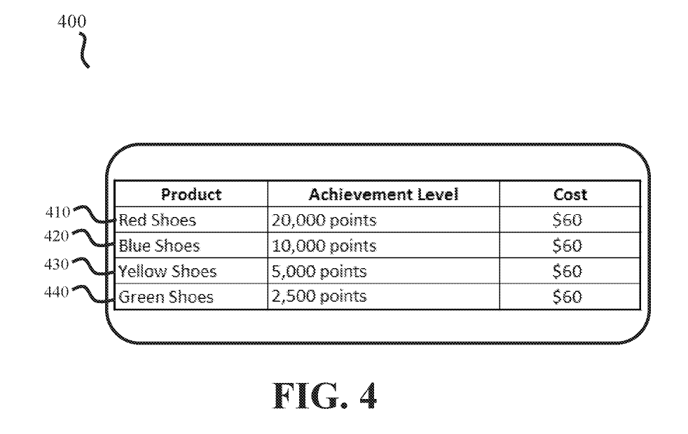

FIG. 4 shows an exemplary mapping 400 of products to achievements. For example, as shown in row 410 in FIG. 4, the red shoes may be made available, or “unlocked,” to a user who has accrued 10,000 points. When unlocked the user may purchase the red shoes for $60. Of course, many schemes may be employed for mapping achievements to products or services, which may be made available at a cost, at no cost, or in other ways.

Achievement server 110 may use an award schedule that associates availability of particular products, lines of products, services, lines of services, experiences, or benefits with a something other than points, as described herein above.

Products, services, and benefits that may be available based on the award schedule include, but are not limited to, shoes, shirts, pants, ballcaps, styled hats, glasses, watches, beanies, electronics (computers, monitors, televisions, hard drives), accessories (computer mouse, phone cases, and other accessories that may be designed or fashioned to signify or reflect a particular achievement), sunglasses, belts, other apparel, figurines, stickers, bags, briefcases, software, exclusive product lines, access to events, access to venues, membership in an association or group, access to online associations, access to online venues, access to electronic content, or any other product, service, or award that may signify or reward one or more virtual environment achievements. Based on virtual environment achievements, these products, services, and benefits may be made available at a reduced cost, at no cost, on an accelerated schedule, or in any other manner known in the art to reward and signify one or more virtual environment achievements.

In one embodiment, a product, service, event, or benefit that becomes available to a user or group of users may be referred to as being “unlocked” for that user or group of users.

The products and apparel that become available based on points or other achievement systems may be marked, styled, colored, and/or designed in a particular and/or distinctive manner to signify one or more virtual environment achievements. For example, shoes may have coloring, design, marking(s), logo(s), words, or a combination of such to signify a particular achievement, set of achievements, point level, or achievement level.

In one exemplary embodiment, achievement apparel and products may be available in a tier system. For example, achievement shoes may be available in a three-tier system. First-tier shoes may require anywhere from a day to two weeks depending on how much time the player plays for an average-skill-level user to be able to unlock the first-tier shoes. Second-tier shoes may require approximately 1-2 months to unlock. Third-tier shoes may require 3-5 months to unlock. A person of ordinary skill will recognize that achievement levels, e.g., points, may map to product availability in many ways, through many functions.

Additional awards, such as sponsorship or viewership on, e.g., YouTube® or Twitch®, may be associated with particular achievement levels or tiers.

In one embodiment, the achievement server may provide an interface with components for users or group users to organize, publicize, and otherwise administer one-on-one competitions, or tournaments, or team competitions, or other competitive events. In such events, users or group users may bet or risk points or other achievement level status, and may win or lose points or other achievement level status based on performance in the event.

In some embodiments, it may be possible to acquire points or other achievement level status in exchange for money or other alternate consideration.

In some embodiments, the award schedule may be dynamically generated based on holidays, product availability, and other facts known to a person of skill in the art.

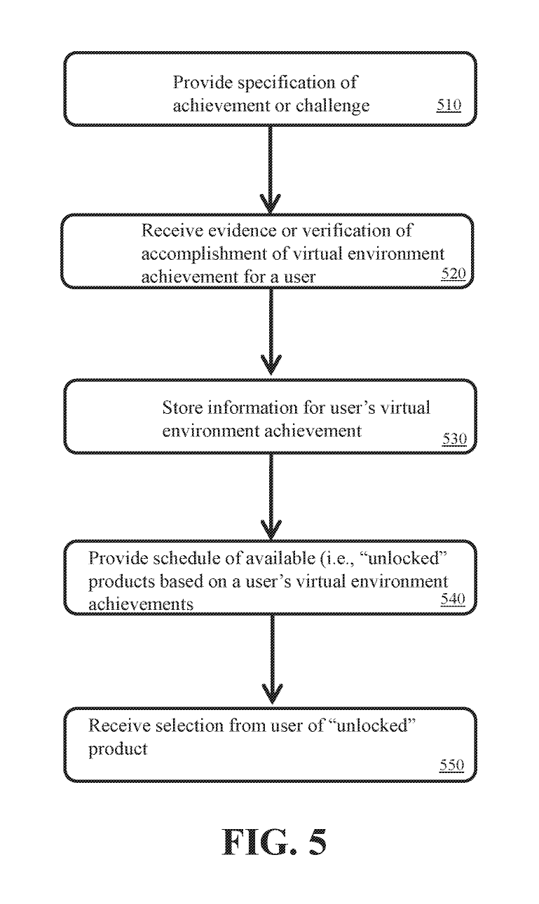

FIG. 5 shows a flowchart of an exemplary method 500 for mapping virtual achievements into real life

At step 510, an achievement server may provide a description or specification of an achievement to a user or to a user's device or to some other device.

At step 520, the achievement server may receive evidence, from a user, or from a user's device, or from some other device, of a user's accomplishment of a virtual achievement.

At step 530, the achievement server may store information relating to the user's report virtual achievement.

At step 540, the achievement server may provide, to the user, or to the user's device, or to some other device, a schedule of available, i.e., “unlocked,” products or services based on the user's virtual environment achievements.

At step 550, the achievement server may receive, from the user, or from the user's device, or from some other device, a selection of an “unlocked” product or service.

These steps are merely exemplary, and may be performed with different variants and in varying orders as may be appropriate for specific applications.

1. A method, comprising:
receiving an achievement report at a server, the achievement report comprising a report of at least one achievement in a virtual environment or a pseudo-virtual environment; and
unlocking, based at least in part on the received achievement report, a real-world product or service.

2. The method of claim 1, wherein the achievement report comprises a report of at least one achievement in a virtual environment.

3. The method of claim 2, further comprising providing one or more achievement descriptions.

4. The method of claim 1, wherein a pseudo-virtual environment is an augmented reality environment.

5. The method of claim 2, wherein the virtual environment is a video game or a computer game.

6. The method of claim 2, wherein:
an achievement report comprises a report of one or more achievements in the virtual environment; and
an achievement in the virtual environment is based on at least one of, in the virtual environment:
attaining a score;
obtaining one or more items;
achieving one or more milestones;
completing a task in a particular amount of time;
completing a level;
achieving a minimum outcome in a head-to-head multiplayer, or comparison competition;
maintaining a particular performance level; and
completing a daily challenge.

7. The method of claim 2, wherein unlocking comprises making available at a cost, or at a reduced cost, or for free, a product or service.

8. The method of claim 7, where the product is apparel.

9. The method of claim 8, wherein the apparel is shoes.

10. The method of claim 9, wherein different colors of shoes are associated with different achievement levels.

11. The method of claim 2, wherein unlocking comprises determining that two or more achievements in the virtual environment map to a minimum achievement level.

12. The method of claim 1, wherein the achievement report comprises achievement verification.

13. The method of claim 12, wherein achievement verification is based on at least one of:
a screenshot;
a video;
credentials;
a code; and
third-party verification.

14. A system, comprising a computer server configured for:
receiving an achievement report at a server, the achievement report comprising a report of at least one achievement in a virtual environment; and
unlocking, based at least in part on the received achievement report, a real-world product or service.

15. The system of claim 14, further configured for providing one or more achievement descriptions.

16. The system of claim 14, wherein the virtual environment is a video game or a computer game.

17. The system of claim 14, wherein:
an achievement report comprises a report of one or more achievements in the virtual environment; and
an achievement in the virtual environment based on at least one of, in the virtual environment:
attaining a score;
obtaining one or more items;
achieving one or more milestones;
completing a task in a particular amount of time;
completing a level;
achieving a minimum outcome in a head-to-head multiplayer, or comparison competition;
maintaining a particular performance level; and
completing a daily challenge.

18. The system of claim 14, wherein unlocking comprises making available at a cost, or at a reduced cost, or for free, a product.

19. The system of claim 18, wherein the product is shoes.

20. The system of 14, wherein:
the achievement report comprises achievement verification; and
achievement verification is based on at least one of:
a screenshot;
a video;
credentials;
a code; and
third-party verification.
